(19) United States
(12) Patent Application Publication
(10) Pub. No.: US 2006/0233918 A1
(43) Pub. Date: Oct. 19, 2006

(54) Crunchy sandwich food seasoner

(76) Inventor: Shangi Montego Jones, Santa Monica, CA (US)

Correspondence Address: LAUSON & ASSOCIATES, 1334 PARK VIEW AVENUE, SUITE 100, MANHATTAN BEACH, CA, 90266, US

(21) Appl. No.: 11/109,419

(22) Filed: Apr. 19, 2005

(51) Int. Cl. A21D 13/00

(52) U.S. Cl. 426/94

(57) ABSTRACT

A sandwich food product includes a pair of bread portions and a meat product therebetween, and a generally flat, potato, corn or tortilla chip of about the same size and shape as the bread portions. The chip has strong seasonings, preferably flavored with conventional condiments such as ketchup, mustard, mayonnaise or the like, or foods such as sauerkraut, chili, etc. The chip is further sealed so as to substantially repel moisture. Perforations are also added to the chip to aid in breaking the same when eating the sandwich. The consumer is able to conveniently enjoy a sandwich with a crunchy chip taste and with an appropriate and even distribution of a seasoning.

### CROSS REFERENCE TO RELATED APPLICATIONS

This application is based on provisional patent application No. 60/562,522 filed Apr. 16, 2004.

### FIELD OF THE INVENTION

The present invention relates to food products, and more particularly to seasoning chips placed inside a sandwich to enhance the flavor of the sandwich food product as well as add a desirable crunchiness.

### BACKGROUND OF THE INVENTION

Snack food manufacturers are responsible for producing some of the world's most popular foods. Most snack foods are generally eaten straight from their packaging. In this instance, a consumer takes a portion of the snack food product from the packaging and places it directly into his/her mouth. Snack foods such as cookies, crackers, potato, corn and tortilla chips can be eaten by themselves or supplemented with other food products.

Consider these food combinations:
Cookies and ice cream
Crackers and soup
Potato, corn or tortilla chips and sandwich food products
Tortilla chips and meat, vegetables, etc., for nachos

Of all the snack food products produced by snack food manufacturers, potato, corn and tortilla chip products are the most popular when it comes to combining a snack food with a sandwich food product. In this instance, the snack food product is supplemented with the sandwich food product to create a more fulfilling meal for the consumer. Similar to supplementing French fries with a hamburger, supplementing potato, corn or tortilla chips with a sandwich transforms the chips from being just a snack, to being a significant part of what makes the two a meal.

For many years, people have eaten standard potato, corn or tortilla chip products with their sandwich food products. Some people, while eating the combination of sandwich and chips, place their chip products inside their sandwich to give it an extra flavorful crunch. The flavor and crunchiness aspects of the chip can add a new and unforeseen dimension to the sandwich eating experience.

In most cases, however, standard snack chip products do not fulfill the consumer's desire of experiencing a flavor enhancing crunchiness throughout the entire eating of the sandwich food product simply because standard snack food chips are neither processed nor designed in a way that allows them to maintain the integrity of their structural design, flavor value and or crunchiness after being placed and eaten within a sandwich food product.

Condiments such as ketchup, mustard, and hot sauce are commonly placed in or on a sandwich food product for the purpose of adding to or enhancing the taste of the food product. These condiments are usually provided in forms that are liquid or considered non-solids. Garlic, onion, and sea salts are solid forms used to season or enhance the flavor of a food product.

Although it is a common practice to use both solid and or non-solid food seasoners to enhance food products, these are a few of the common problems related to both solid and non-solid seasoners:
Pouring too much of a solid seasoner can over season;
Pouring too much of a non-solid seasoner as in ketchup or hot sauce can over season as well as cause the food product to become soggy;
Under seasoning can leave the food product tasting bland and unsatisfying;
Neither solid nor non-solid seasoners, in and of themselves, add a desirable flavor enhancing crunchiness to a food product.

The present invention provides a method for seasoning food products, especially sandwich food products, that allows the seasoning attributes of both non-solid and solid food seasoners to be applied in pre-formulated amounts to a chip or chip-like product for the purpose of producing a seasoning chip that can be used to introduce seasonings and flavor enhancers, as well as a flavor enhancing crunchiness, to other food products.

As stated earlier, standard snack food chips are designed and meant to be eaten straight from their packaging. They can also be placed and served in a dish but the method by which they are eaten is still the same; a consumer takes a portion from the package or dish, places it in his/her mouth and eats the snack chip product. Other variations of this method can include using the chip to acquire dips or sauces, or combing foods and sauces with chips to make nachos. Both of these methods still require the consumer to use a hand or utensil to acquire a chip and then place it, with the dip or other foods, into his/her mouth.

The method by which the present invention is eaten requires a consumer to place the seasoning chip inside of a sandwich food product and then simultaneously eat the chip and sandwich product while the chip is inside the sandwich food product. Although the art and technology between standard snack chip products and the present invention are similar, the following key elements enable each of them to soundly establish their own identity in the field of snack food products:

| STANDARD SNACK | PRESENT INVENTION'S |
|---|---|
| CHIP PRODUCTS | SEASONING CHIP |
| Eaten straight from package | Placed and eaten within |
| Seasoned or flavored at | sandwich food products |
| levels sufficient for | Seasoned or flavored at |
| consumers to eat straight | levels that will enable chip |
| from package | to be used as a seasoning |
| Moisture barriers designed | tool |
| to protect against effects that | Moisture barriers designed |
| occur during normal | to protect chip against the |
| package-life and | effects of being sandwiched |
| consumption practices | Chip texture reinforced; |
| Are generally made from | provides crunchier chip |
| potato or corn | Methodically placed/inserted |
| Standard snack chips not | into a sandwich food product |
| meant or designed to: | Designed to add crunchiness |
| Be placed and eaten within a | to a sandwich food product |
| sandwich food product | Can be made from grain, |
| Season or enhance the flavor | vegetable, fruit, meat and or |
| of sandwich food products | dairy food products |
| Add crunchiness to a | Present invention not |
| sandwich food product | meant or designed to: |
| Withstand the effects of | Be eaten straight from |
| being sandwiched by the | package like standard snack |
| breads or foods used to make | chip products |
| sandwich food products | |

Again, adding flavor and crunchiness to a sandwich food product are the two most significant reasons why consumers have been known to place standard snack food chips in their sandwich food products. These two features, flavor and crunchiness, make potato, corn and tortilla snack chip products rank highest among the popular snack foods produced by snack food manufacturers.

Snack chip technology seems to focus the majority of its efforts toward enhancing the tastes and textures of snack chips. Manufacturers spend millions of dollars annually on developing the processes and methods used to improve those flavors and chip textures most desired by consumers.

Standard snack chip technology suggests that the processes and or methods used to seal or coat snack chips greatly improves the finished product's flavor and ability to maintain its crispy texture. This area of snack chip technology focuses on adding to or enhancing snack chip products by means of sealing or coating the chip with solid or liquid seasonings, flavorings, colorants, moisture barriers, vitamins and minerals, and or odorants and fragrances.

Protecting the chip's flavor and crispy texture are the two most important factors when it comes to sealing or coating snack food chips. Although these practices are successful, there is no special area of interest in the art or technology that suggests snack chips made using currently or previously used methods are designed to season or enhance the flavor of or add a desirable crunchiness to sandwich food products. Moreover, nowhere in the field's art or technology does it describe or suggest that standard snack food chip products can or should be used as a tool, or means to season or enhance the flavor of and add a desirable crunchiness to a sandwich food product.

Furthermore, standard snack food chip technology's processes and methods, both previously and currently used to produce snack food chips or chip-like products, neither specify the intention to protect the snack chips from the effects of being sandwiched by the breads and other foods used to make sandwich food products, nor do these processes or methods protect the snack food chips from the effects of being sandwiched by the breads, buns, rolls, shells or crusts and other various foods and or condiments used to make sandwich food products.

When consumers do attempt to place snack foods or standard snack food chip products, particularly potato, corn or tortilla chip products, in their sandwich food products, the desired experience of having a flavor enhancing crunchiness throughout the entire eating of the sandwich is not attained because of these reasons:
Chips become soggy once exposed to moisture from meat and vegetable juices, and or condiments such as ketchup, mustard, mayonnaise, etc.
The flavor value of standard snack food chips is too low, making it hard to determine the flavor of the chip once it is placed and eaten within a sandwich food product.
Sandwich contents overwhelmed the flavor and crunchiness of chips.
The structural design of the chips is unable to give the consumer a flavorful crunchiness with every bite of the sandwich food product.
Methods for calculating the flavor levels for chip seasoning or flavoring are based on the chips being taken from the packaging and placed directly into the consumer's mouth as oppose to the chips being placed and eaten in other foods.
Various size and shape of chips and chip fragments in the sandwich can give inconsistent crunch or flavoring to sandwich food product.
Standard potato, corn and tortilla chip products fall out of the sandwich product when the consumer bites down on the sandwich product because of the size and design of the chips.
Once a consumer bites into a sandwich product, chips can become overly crushed within the sandwich product causing small bits of chip fragments/particles to pierce gums and or tongue, or become trapped in the consumer's windpipe, causing choking and or vomiting.
Standard snack food chips are not meant or designed to:
   Add a desirable crunchiness to sandwich food products
   Be used as a means to season sandwich food products
   Add a flavor enhancing crunchiness to a sandwich food product
   Be sandwiched between the breads and contents used to make sandwich food products
   Be strategically inserted and eaten inside a sandwich food product

The present invention resolves these issues by doing the following:
Providing one large processed seasoning chip per sandwich or per section of sandwich food product.
Offering the seasoning chip in sandwich specific designs that closely match the borders of the bread used to make sandwich food products, e.g., large circular chips for hamburger buns, elongated rectangular curve-edge chips for hot dog buns, large triangular chips for pizza crust, etc.
Sealing the seasoning chip with a concentrated-flavor-food-based sealant that will enable the flavor/sandwich flavor enhancers to be determined while the chip is being eaten within the sandwich.
Sealing the seasoning chip with a concentrated-food-base sealant that will enable it to better withstand moisture once it is introduced to and sandwiched by the contents of a particular sandwich food product.
Allowing various degrees of chip thickness to prevent crushing of the product once it is introduced to and eaten within the contents of a particular sandwich food product.
Systematically perforating the seasoning chips to prevent them from being completely crushed once a consumer bites down on the sandwich food product.
Adding directions to the packaging that instruct the consumer to:
   1. Remove from the package, one seasoning chip that is designed in accordance with the present invention.
   2. Methodically insert or apply the seasoning chip in a sandwich food product for the purpose of seasoning and adding a flavor enhancing crunchiness to a sandwich food product.
   3. Simultaneously eat the seasoning chip and sandwich food product while the chips are inside the sandwich food product.
   4. Fully realize the present invention by experiencing seasonings and flavor enhancing crunchiness throughout the entire eating of the sandwich food product.
Designing seasoning chips that are specific made and intended to:
   Add a desirable crunchiness to sandwich food products
   Be used as a means to season sandwich food products
   Add a flavor enhancing crunchiness to a sandwich food product
   Be sandwiched between the breads and contents used to make sandwich food products
   Be strategically inserted and eaten inside a sandwich food product

Again, consumers have been known to place standard snack food products or standard snack chip products within their sandwich food products, but, due to the processes and methods used to produce standard snack food chips, fail to fulfill their desire of having a flavor enhancing crunchiness throughout the entire eating of the sandwich food product.

Other factors that support the present invention's effort to establish itself as its own food form, separate from the standard snack food chips produced by manufacturers all across the world, involve the means by which standard snack chips are prepared. The processes and methods by which standard snack food products can be prepared vary depending upon the desired result of the finished product. Issues such as fat content, the kind of chip, e.g., potato, corn, or tortilla, the chip flavoring, the chip product's weight, thickness, texture, crunchiness or the lack thereof, as well as the package/shelf-life, all dictate the preferred means by which snack food chip products are prepared.

Potato, corn and tortilla chips can be prepared by means of frying in some form of fat, low fat or non-fat oil or by baking. Likewise, cookies, cracker and some pastry snack products can be baked and even fried in some instances. Still, although these standard preparatory processes vary in the steps by which they prepare snack food products, none of these processes produces a snack food product, particularly a seasoning chip, that is methodically, purposefully and specifically designed to maintain the integrity of its dimensional design or its sandwich flavor enhancing crunchiness after being placed and eaten within a sandwich food product.

What separates the present invention's preparatory process and methods from all other snack food processes is that it uses snack chip technology to produce seasoning chip products that can be used as a tool, or means for seasoning and adding a flavor enhancing crunchiness to a sandwich food product. The present invention further builds on standard snack chip technology by broadening the scope of what foods can be made into snack chips.

The present invention's preparatory process is not limited to producing grain or vegetable based snack chips, e.g., potato, corn, or tortilla chip products. The present invention's process allows for any and every food to be made into a form similar to snack chip products. Grains, vegetables, fruits, meats and dairy products can be made into seasoning chips using methods comprised in the present invention's process.

No matter what food or ingredient is used to prepare a seasoning chip batter, dough, etc., the present invention's process will render a final product that is purposely designed and specifically meant to:
Add a desirable crunchiness to sandwich food products
Be used as a means to season sandwich food products
Add a flavor enhancing crunchiness to a sandwich food product
Be sandwiched between the breads and contents used to make sandwich food products
Be strategically inserted and eaten inside a sandwich food product

Prior art in the field of snack chip products, particularly potato, corn and tortilla chip products, suggests that the field's creative intentions are set around designing new flavors, fancy product packaging, reformulating or reducing fat content and in some cases, making slight modifications to designs that are over twenty years old, e.g., a corn chip that is shaped like a scoop, enabling it to be used as a dipping utensil.

The field is over saturated with flavors that have no true flavor value or uniqueness. Flavors such as, Extra Cheese, Extra Spicier Cheese, Nacho Cheese and Extra Cheesy Nacho, are introduced to consumers by manufacturers who then, in turn, not even six months later, promote chip campaigns that reintroduce flavors such as Original Nacho Cheese, which actually taste like Extra Nacho Cheese without the “Extra.”

These series of flavors are usually followed by a Low Fat Nacho Cheese series, that can include flavors like, Low Fat Cheesy Nacho, Cheesier Low Fat Nacho, and finally, No Fat Spicy Cheese Nacho, which claims to be cheesier than the cheesiest cheese flavored chip on the market, but is actually no cheesier than its fat containing counterpart, Original Spicy Cheese Nacho.

Again, the field's prior art suggests that none of these manufacturers has regarded the consumer's need or desired to have a chip product that is innovative in flavor value, design or purpose. The present invention, however, does this in that it provides innovative flavoring methods, chip designs, and purpose or methods for eating the seasoning chip product that allow the chip product to be used to season and add a flavor enhancing crunchiness to sandwich food products.

Although the present invention's process produces a seasoning chip, the invention is not fully realized in the seasoning chip itself. The invention is fully realized in the complete process, which includes the methods of preparation, the chip prepared according to the methods of the process, the structural design of the chip which includes a system of perforating the chips—these perforations help prevent the chip from being completely crushed once a consumer bites down on a sandwich food product—the method of sealing or coating the chip, both the instruction to insert and method of insertion, and finally, the requirement of eating the seasoning chip and sandwich food product while the seasoning chip is within the sandwich food product.

The simultaneous eating of the seasoning chip and sandwich food product is included in the process because it is in this last phase that the seasonings and flavor enhancing crunchiness is experienced by the consumer.

Again, the present invention is not seen in the seasoning chip alone. The present invention is a process that produces seasoning chips, and then instructs consumers to place these chips inside of sandwich food products for the purpose of adding a flavor enhancing, crunchiness to the sandwich food product that can be experienced throughout the entire eating of the sandwich food product.

Insofar as the inventor is aware, no snack food, or snack food chip formerly developed has ever been designed or processed in a way that specifically intends for it to:
A. Be called a seasoning chip.
B. Be placed and eaten within a sandwich food product.
C. Be used to season and or enhance the flavor of a sandwich food product.
D. Add crunchiness to a sandwich food product.

### SUMMARY OF THE INVENTION

The present invention is a process which includes methods for preparing and eating seasoning chip products. A more practical view of the present invention depicts it as a means of adding seasonings and flavor enhancing agents to a sandwich food product. Normally, seasonings and flavor enhancing agents are sprinkled or poured on to a food product.

The present invention provides a means for adding seasonings and flavor enhancing agents to a sandwich food product via placing a highly seasoned crispy-textured seasoning chip product inside the sandwich food product. The seasonings enhance the flavor of the foods used to make the sandwich food product, while the chip adds a desirable crunchiness to the sandwich that can be experienced throughout the entire eating of the sandwich food product.

The process is comprised of steps that include:
Combining ingredients to form seasoning chip products that match the borders of the breads, buns, rolls, and crusts, used to make sandwich food products;
Preparing the foods and or combined ingredients by means of frying, drying and or baking;
Treating the prepared snack food chip with a high flavor value food-based sealant that will;
   A. Protect the chip from becoming soggy due to moisture from foods, sauces and or condiments in a sandwich food product.
   B. Seal the chip with seasonings and flavorings so as to enable it to be used to season and or enhance the contents of a sandwich food product.
Instructing the consumer to insert/apply a snack food chip in a sandwich food product using methods constructed in accordance with the invention, and finally;
Requiring the consumer to eat the snack food chip while it is inside the sandwich food product.

There is accordingly a need in the art and would be highly desirable to provide a seasoning chip product that has qualities that will enable it to better maintain the integrity of its structural design, flavor value and crispy texture and can also be used to add seasonings and a flavorful enhancing crunchiness to a sandwich food product.

It would also be highly desirable to provide a seasoning chip product that is specifically made to be placed and eaten in a sandwich food product for the purpose of adding seasonings and or a flavor enhancing crunchiness to a sandwich food product.

Further, it would be highly desirable to provide a crispy chip-like product that can be used as a means to add various types of pre-formulated levels of seasonings, flavorings, additives, etc., to a sandwich food product.

Therefore, it is a principal object of the present invention to provide a seasoning chip or, chip-like product that is designed to season and add a flavor enhancing crunchiness to a sandwich food product and methods for producing the same.

Still further, several objects and advantages of the invention are to provide seasoning chips that are similar in whole or in part to the texture, ingredients and flavor of some standard brand cookie, cracker, cake, fruit, potato, corn or tortilla chip snack food products, and can be made in whole or in part from the grains, vegetables, fruits, meats, and or dairy products used to make such snack food products.

A general object of the present invention is to provide a seasoning chip that offers a higher concentrated flavor value in each individual chip so that the flavor of the chip is not overwhelmed by the various contents of the sandwich food product once it is placed and eaten within a sandwich food product.

Another object of the invention is to provide a seasoning chip that is able to maintain the integrity of its design once the chip is placed and eaten within a sandwich food product.

Yet, another object of the invention is to provide a seasoning chip that is systematically perforated; these perforations will aid in preventing the chip from being completely crushed once it is placed and eaten within a sandwich food product.

Another object of the invention is to provide seasoning chips that can be comprised, in whole or in part, of grain, vegetable, fruit, meat, and or dairy products, a form of these foods, and/or a form of the bi-products produced from these foods.

Another general object of the invention is to provide a seasoning chip that can be used as a seasoning tool to season and enhance the flavors or foods used to make sandwich food products as well as add a flavor enhancing crunchiness to the sandwich food product.

Another object of the invention is to provide seasoning chips that are sandwich food product, or sandwich bread specific, e.g., circular chips to match the circumferential borders of hamburger buns, elongated curved-edge rectangular chips for hot dog buns, submarine sandwiches buns and burritos, large triangular chips to match or closely match the angles and borders of pizza crust slices, as well as curved-edge square chips to match the borders of standard loaf of bread slices.

Still yet another object of the invention is to provide a seasoning chip that can add a flavor enhancing crunchiness to pizza, burritos, tacos, corn dogs, pita bread sandwiches, hamburgers, hot dogs, corn dogs, sub marine sandwiches and any other sandwich food product.

These and other, further and more specific objects and advantages of the invention will become apparent to those skilled in the art from a study of the following detailed description thereof, taken in conjunction with the accompanying drawings.

### BRIEF DESCRIPTION OF THE SEVERAL VIEWS OF THE DRAWINGS

FIG. 1 shows a shape for chips for standard loaf of bread-type sandwich food products;

FIG. 2 shows a chip shape for breads, buns, rolls or shells used to make hot dog, submarine sandwich, and or burrito-type sandwich food products;

FIG. 3 shows a chip shape for circular shaped breads or buns used to make hamburger-type sandwich food products;

FIG. 4 is a chip shape for breads or crust used to make pizza-type sandwich food products;

FIG. 5 shows a loaf-of-bread chip, with systematic perforations;

FIG. 6 shows a hot dog, submarine sandwich, or burrito-type chip with systematic perforations; and

FIG. 7 shows a hamburger-type sandwich food product chip with systematic perforations; and finally,

FIG. 8 shows a pizza-type chip with systematic perforations;

FIG. 9 depicts the steps involved in the process and methods of the present invention;

FIG. 10 is an exploded view of a standard loaf of bread sandwich food product;

FIG. 11 is a view of a standard loaf of bread-type sandwich food product after the chip has been inserted;

FIG. 12 is an exploded front perspective view of a hot dog prior to chip insertion’

FIG. 13 is a view of a hot dog post chip insertion;

FIG. 14 is a view of a burrito pre chip insertion;

FIG. 15 is a view of a burrito post chip insertion;

FIG. 16 is an exploded frontal view of a hamburger;

FIG. 17 is a view of a hamburger post chip insertion;

FIG. 18 is a view of a slice of pizza pre-chip insertion; and,

FIG. 19 is a view of a slice of pizza post insertion.

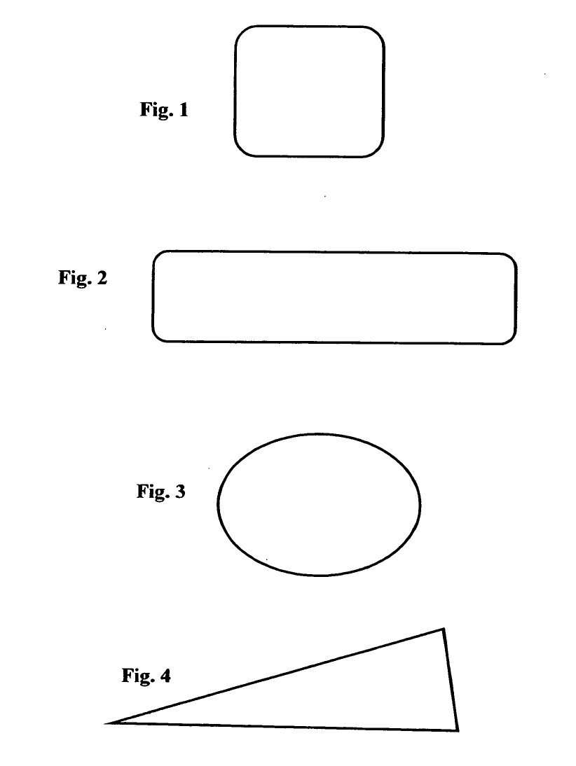

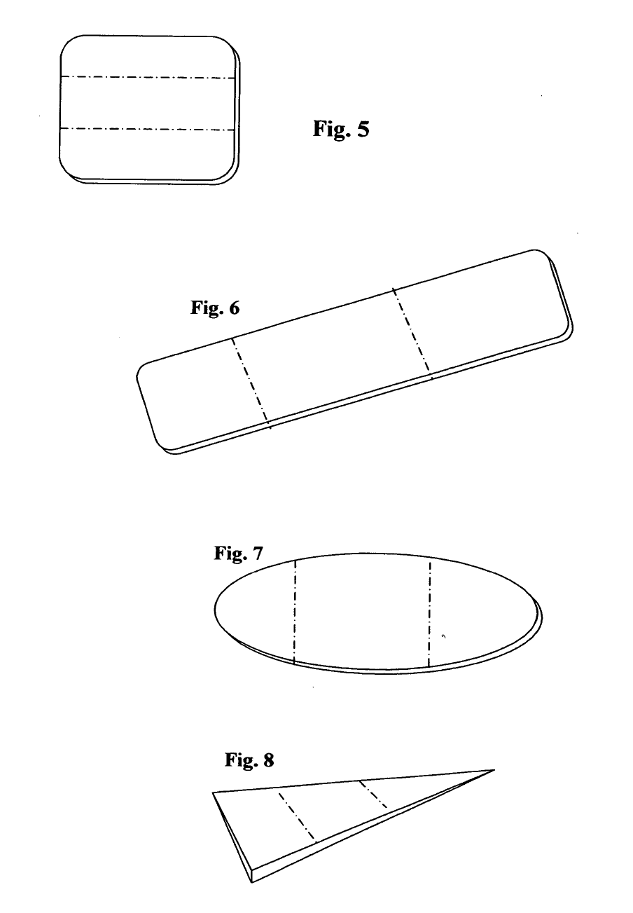

### DESCRIPTION OF THE PREFERRED EMBODIMENTS

In operation one obtains a seasoning chip constructed in accordance with the invention and, depending upon the type of sandwich food product, the consumer is instructed to strategically place the chip product inside the sandwich food product for the purpose of seasoning and adding a flavor enhancing crunchiness to the sandwich food product, and then simultaneously eat the seasoning chip and sandwich food product while the snack food chip is inside the sandwich food product.

In doing this, a consumer can experience eating a sandwich food product that is desirably seasoned and also has and offers a flavor enhancing crunchiness throughout the entire sandwich food product. Where there previously was no product specifically made to fulfill this desire, the present invention specifically offers consumers a method and means for seasoning and adding a flavor-enhancing crunchiness to a sandwich food product.

Furthermore, because standard snack chip products are neither made nor designed to season and or add a flavor enhancing crunchiness, or be placed in and eaten within a sandwich food product, the present invention's method and means for seasoning and adding a flavor enhancing crunchiness to a sandwich food product are not only better suited, but are also the only means and method of the field's art and technology that produce a product that is specifically made and designed to do so.

Still further, it is to be understood that the present invention's process and methods therein, are not to be limited to any specific kind of food, e.g. grains, vegetables, fruit, etc., any particular kind of seasoning, herb, spice or sweeter, e.g. salt, onion salt, garlic salt, rosemary, sugar, etc., any specific method of preparing or cooking the product, e.g., frying, drying or baking, or any specific kind of sandwich food product, e.g., hamburgers, hot dogs, tacos, burritos, pizza, etc.

Also, the method by which the seasoning chips are shaped or design cannot be limited to those depicted in this application due to the various types of sandwich food products and for example the shape that would be required to fit a corn dog or a shish kebab. Since the effort is to secure the rights to using the chips as a means for adding seasons and or a flavor enhancing crunchiness to a sandwich food product, limiting the invention to a particular shape or design would hinder the invention's ability to fulfill the consumer's desire to thoroughly apply the invention to any and every kind of sandwich food product available.

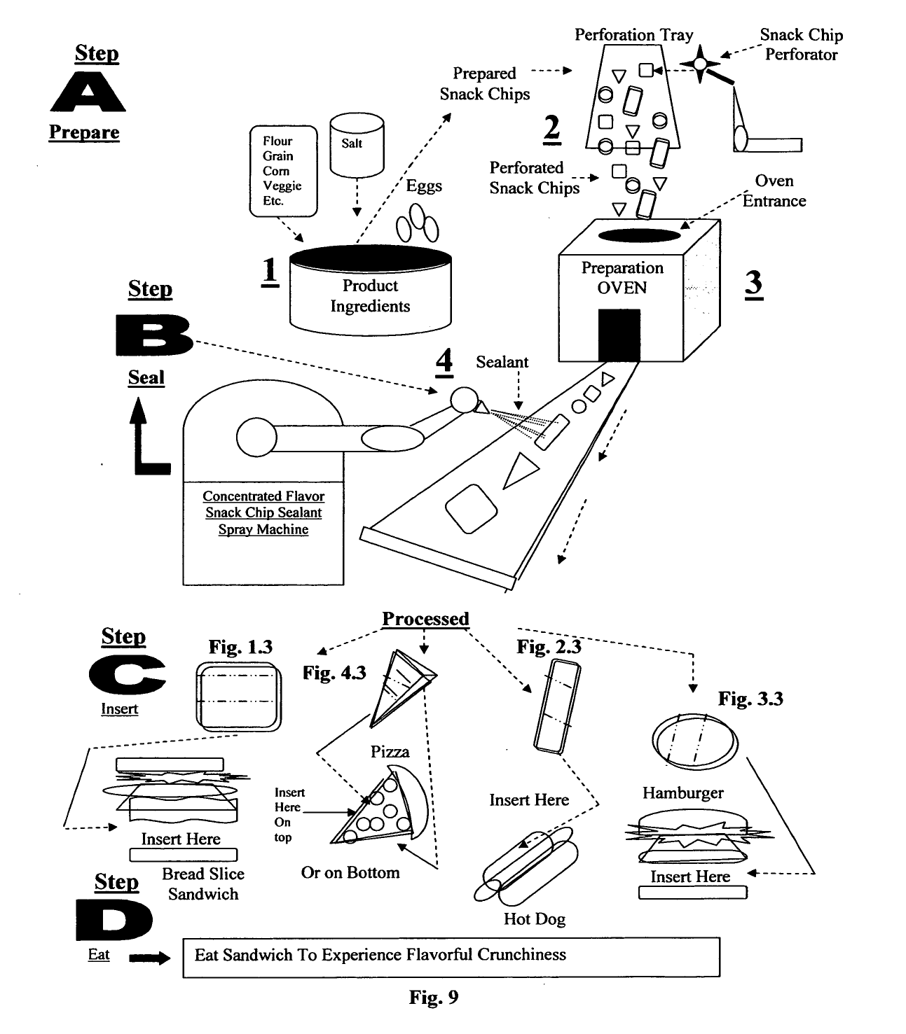

FIG. 9 depicts the steps involved in the P. S. I. E. process and methods of the referenced embodiments of the present invention:
“P” stands for prepare;
“S” stands for seal; as in seal or coat the chip
“I” stands for insert; as in insert the chip; and
“E” stands for eat; as in eat the sandwich and chip.

The diagram as labeled is largely self-explanatory; (A) various food and ingredients are combined to produce a chip batter, etc., the chips are place on a tray and then perforated, the chips are then fried, baked or dried, (B) the chips are then sealed and or coated with high flavor value seasonings and sandwich flavor enhancers as well as moisture barriers, (C) a final product is produced, and finally, (D) consumers are instructed to place and eat the chip inside a sandwich food product.
Steps Involved:
   A. Prepare the food to make chip products;
   B. Seal the chip products will seasons and moisture barriers;
   C. Insert the chip into a sandwich food product;
   D. Eat the chip and sandwich simultaneously to experience added seasonings and flavor enhancing crunchiness.

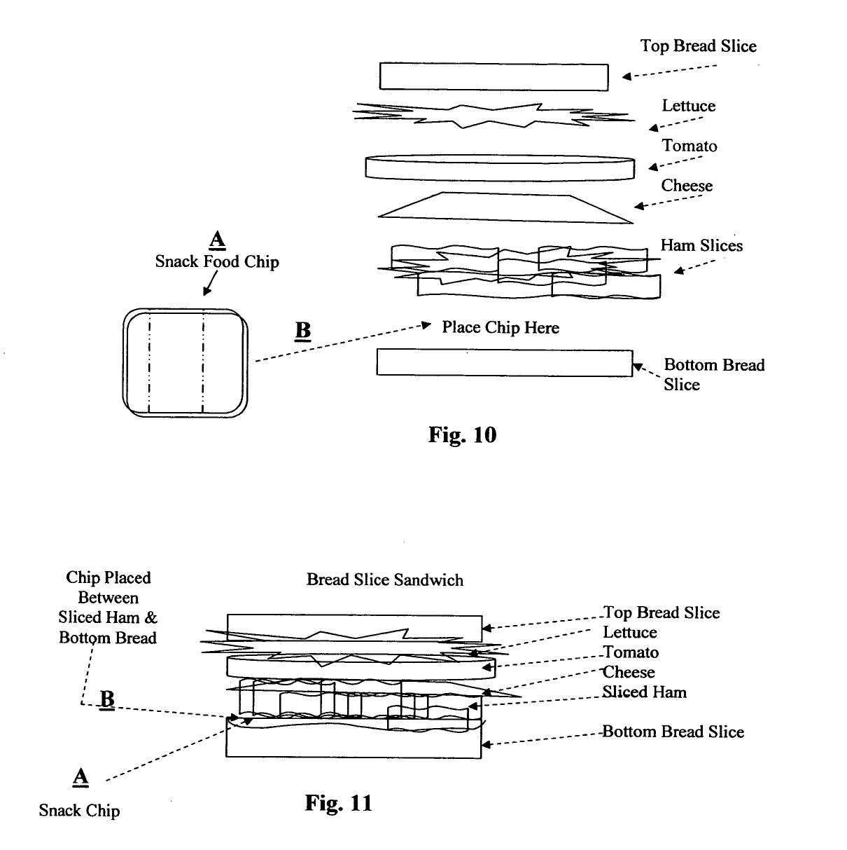

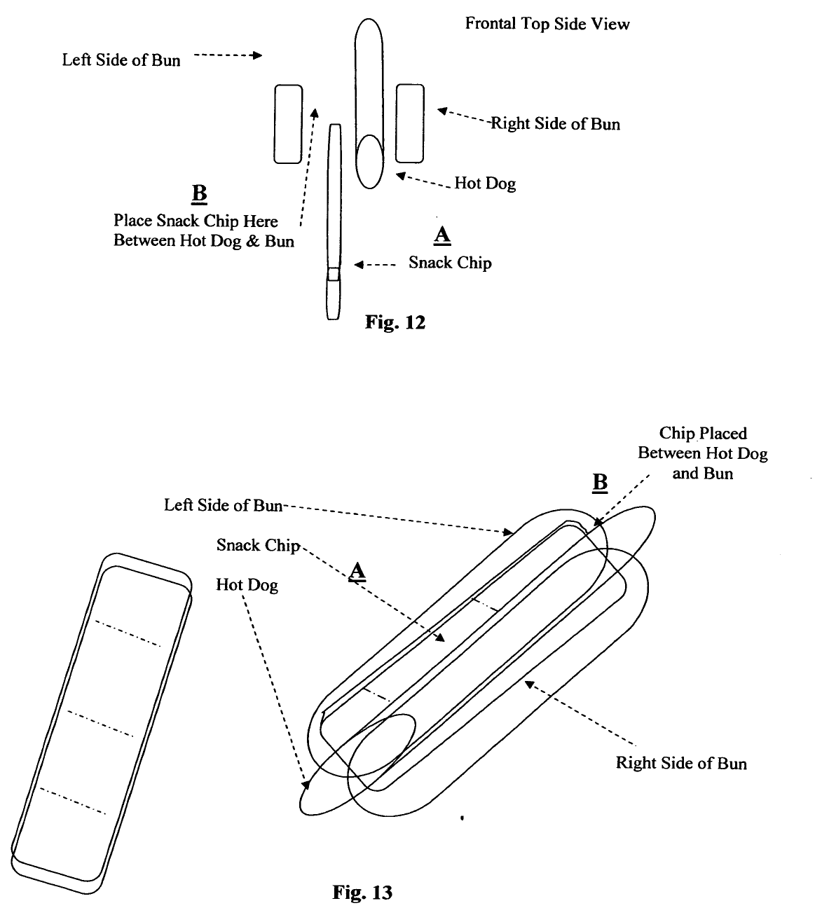

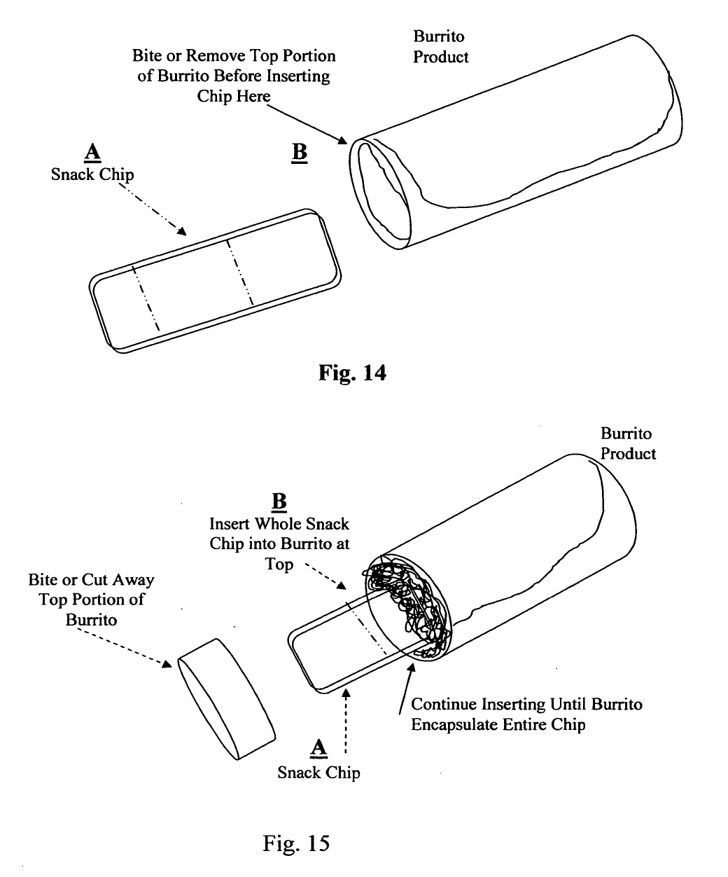

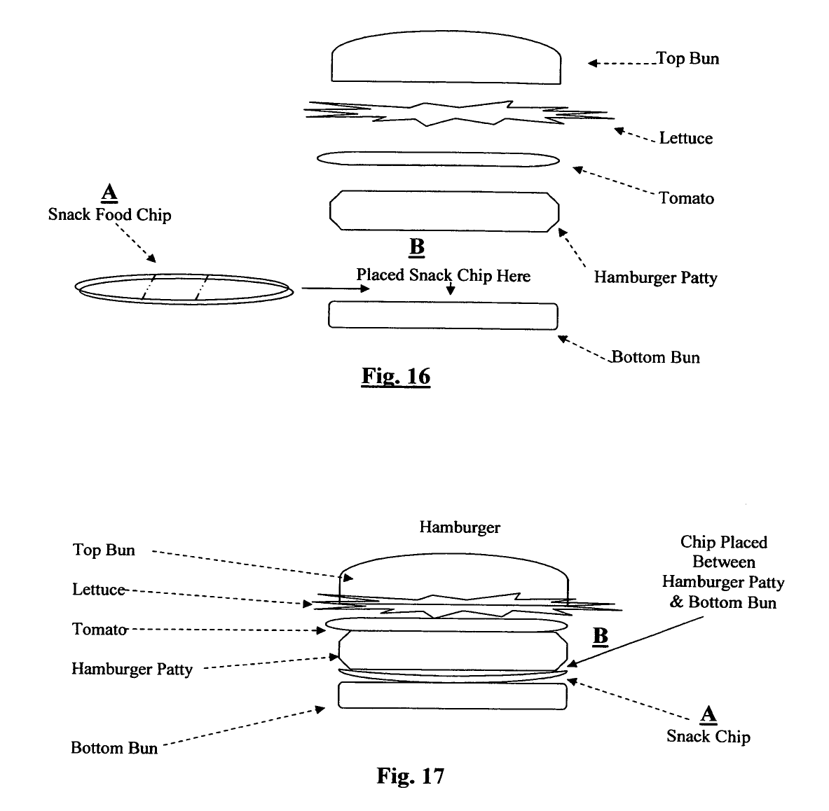

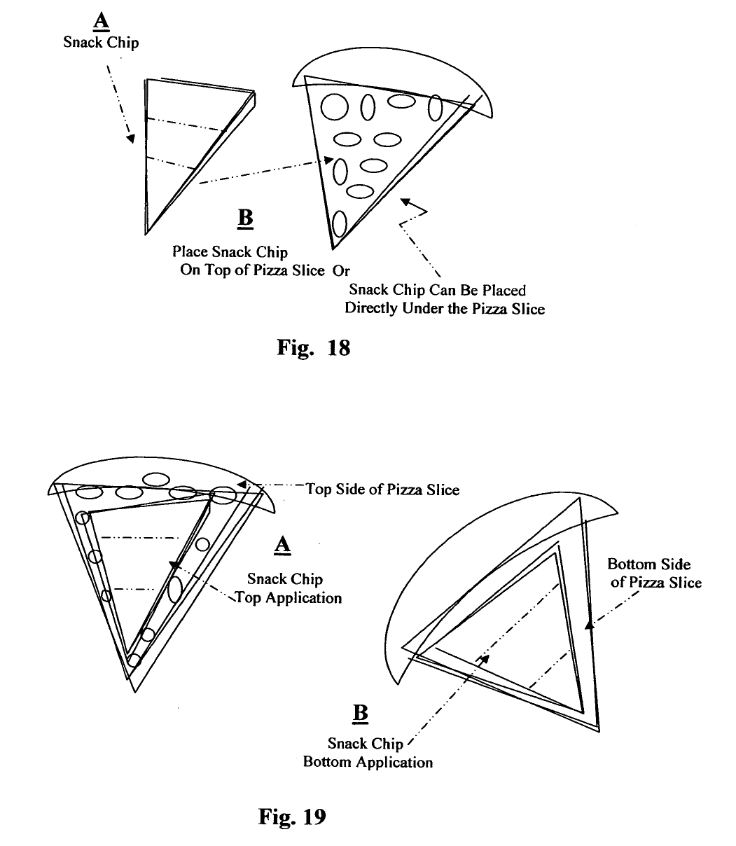

FIGS. 10-19 are exploded and assembled views of standard bread sandwich food products or the like depicting the appropriate chip and its placement in the food product.

The present invention has been described in connection with preferred embodiments, but it is understood that modifications will occur to those skilled in the appertaining arts that are within the spirit of the invention disclosed and within the scope of the claims.

What is claimed is:

1. A sandwich food product comprising:
a pair of bread portions of a selected size and shape;
a meat product located between the bread portions;
a generally planar, crunchy chip of generally the same size as the bread portions;
said chip located between said meat product and one of the bread portions;
said chip having pungent seasoning; and,
said chip being substantially sealed to repel moisture.

2. The sandwich food product of claim 1 wherein the chip has one or more perforations to assist in breaking of the chip when eating the food product.

3. The sandwich food product of claim 1 wherein said seasoning is a flavor a condiment selected from the group consisting of ketchup, mustard, relish and mayonnaise.

4. The sandwich food product of claim 1 wherein said chips are selected from the group consisting of potato, corn, tortilla and nacho flavored.

5. A method for providing a food product comprising the steps of:
selecting one or more bread portions of a certain size and shape;
preparing substantially planar snack chips of about said selected size and shape;
adding a strong seasoning to the chips;
sealing the chips such that the chips repel moisture;
placing the chips adjacent said one or more bread portions.

6. The method for providing a food of claim 5 further comprising the step of perforating the chips in one or more locations across the chip.

7. The method for providing a food of claim 5 further comprising the step of adding a layer of meat adjacent the chip.
